(19) United States
(12) Patent Application Publication
(10) Pub. No.: US 2024/0349740 A1
(43) Pub. Date: Oct. 24, 2024

(54) HEMP PRODUCT AND A METHOD AND SYSTEM FOR TREATING HEMP

(71) Applicant: The Apothecary LLC, Portland, OR (US)

(72) Inventor: Jesse Richardson, Vernonia, OR (US)

(73) Assignee: The Apothecary LLC, Portland, OR (US)

(21) Appl. No.: 18/137,999

(22) Filed: Apr. 21, 2023

(51) Int. Cl. A21D 13/04; A21D 2/36; A21D 8/06

(52) U.S. Cl. CPC A21D 13/04; A21D 2/36; A21D 8/06

(57) ABSTRACT

A method is provided for processing a quantity of hemp flower that may include steps of: milling the hemp flower to produce a milled hemp flower; heating the milled hemp flower in an oven; combining the milled, heated hemp flower with a powder substance that includes a coconut powder; and stirring together the milled, heated hemp flower and the powder substance. The method may further include that the powder substance includes yuca root and/or acacia fiber. The method may further include placing the milled hemp flower on a pan to a depth of not more than about 1.5-inches and then baking the milled hemp flower in the oven for about 30 minutes, then removing from the oven and stirring the milled hemp flower and returning the pan and the milled hemp flower to the oven for additional baking for about 20 minutes. The method may further include a step of combining the milled hemp flower with kief.

### BACKGROUND

This disclosure relates in general to methods and systems for treating hemp to prepare a hemp product for use in a variety of products, including teas, food products, nutritional supplements, oils and lotions, and smoking blends. The methods and systems are particularly suited to processing hemp flower through milling and heating stages and combining the hemp with one or more additional substances to produce a hemp base mixture for use in the various products.

Existing methods and systems for treating hemp for consumption and topical use typically start with a dried, cured hemp flower, which may also be milled, for example to the size of a grain of rice. The flower may be baked in an oven in order to achieve a level of decarboxylation, including the conversion of cannabidiolic acid (CBDA) to cannabidiol (CBD), which is a desirable result. However, the existing methods and systems have drawbacks in terms of preparing the flower to be mixed with other substances to make particular products.

### SUMMARY

According to an embodiment of the present disclosure, a method for processing a quantity of hemp flower may include steps of milling the hemp flower to produce a milled hemp flower; heating the milled hemp flower in an oven; combining the milled, heated hemp flower with a powder substance that includes a coconut powder; and stirring together the milled, heated hemp flower and the powder substance. The powder substance used in the combining step of the method may further include yuca root and/or acacia fiber.

The heating step of the method may include placing the milled hemp flower on a pan to a depth of not more than about 1.5-inches and then placing the pan with the milled hemp flower in an oven. The heating step may also include baking the milled hemp flower in the oven at a temperature between about 230° F. and about 240° F. The heating step may also includes baking the milled hemp flower in the oven for about 30 minutes, then removing and stirring the milled hemp flower and returning the pan and the milled hemp flower to the oven for additional baking for about 20 minutes.

The method may include, before the milling step, a first step of removing stems from the hemp flower and may further include, after the milling step, a second step of removing stems from the hemp flower. The method may include a step, before the milling step, of drying the hemp flower. The method may including a step, before the milling step, of curing the hemp flower.

The milling step of the method may include processing the hemp flower to a particle size of not greater than about 2-mm. The milling step of the method may include processing the hemp flower to a particle size of between about 1-mm and about 2-mm.

The method may include that the milled, heated hemp flower and the powder substance define a ratio by weight of the hemp flower to the powder substance of about 1:1.5.

The stirring step of the method may include stirring until the milled, heated hemp flower and the powder substance are evenly distributed and clump-free. The stirring step may also include combining together the milled, heated hemp flower and the powder substance in a sealable container. The method may include, after the stirring step, a step of sealing the container and a step of storing the container in a cool location for a period of between about 24 and about 72 hours. The method may include, after the storing step, a step of homogenizing the milled hemp flower and powder substance.

A system for processing hemp according to an embodiment of the present disclosure may include a supply of hemp flower; a processor configured for milling the supply of hemp flower to produce a milled hemp flower; a pan for receiving the milled hemp flower; an oven for receiving the pan containing the milled hemp flower and baking the milled hemp flower; a supply of a powder substance that includes coconut powder, yuca root, and acacia fiber; and a sealable container configured to receive a combination of the milled, baked hemp flower and the powder substance in a ratio by weight of the hemp flower to the powder substance of about 1:1.5.

A processed hemp product according to an embodiment of the present disclosure may comprise hemp flower; a combination of powdered coconut milk, tapioca maltodextrin, and acacia fiber. The product may include that the hemp flower and the combination define a ratio by weight of the hemp flower to the combination of about 1:1.5.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 is a block diagram of a system according to an embodiment of the present disclosure.

FIG. 2 is a flowchart for a method carried out in accordance with an embodiment of the present disclosure.

FIG. 3 is a flowchart for a method carried out in accordance with another embodiment of the present disclosure.

FIG. 4 is a flowchart for a method carried out in accordance with another embodiment of the present disclosure.

FIG. 5 is a flowchart for a method carried out in accordance with another embodiment of the present disclosure.

In the appended figures, similar components and/or features may have the same reference number or the same number with a letter suffix.

### DETAILED DESCRIPTION

The following detailed description of some exemplary embodiments of the present disclosure do not limit the scope, applicability, or configuration of the other embodiments that will be understood from the present disclosure. The ensuing description will provide those skilled in the art with an enabling description not only for the exemplary embodiment but also other embodiments within the scope of the present disclosure. It is understood that various changes may be made in the function and arrangement of elements without departing from the spirit and scope as set implementing forth in the appended claims.

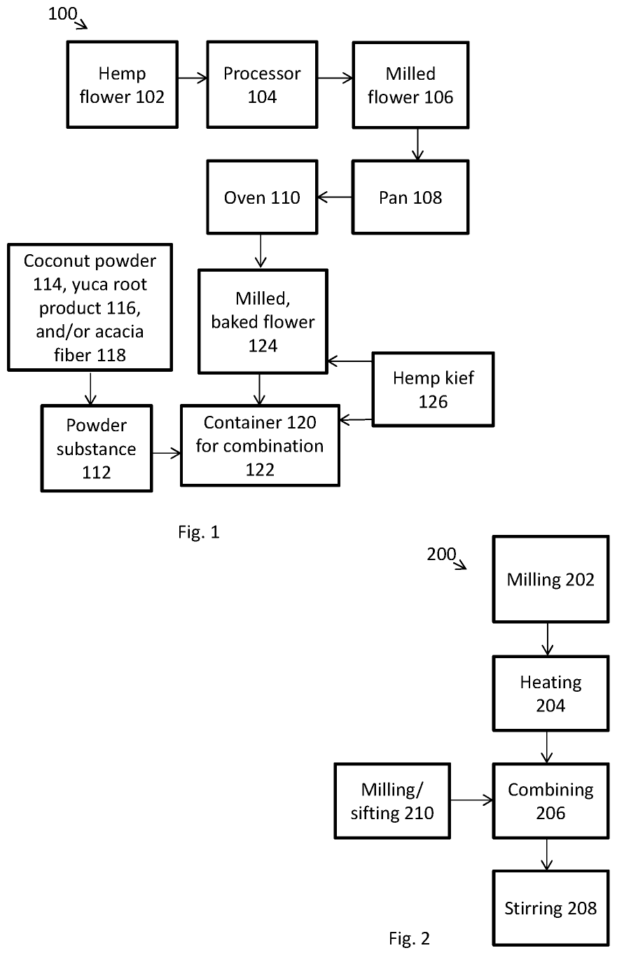

As shown in FIG. 1, a system 100 for processing hemp according to an embodiment of the present disclosure may include a supply of hemp flower 102 and a processor 104 configured for milling hemp flower 102 to produce a milled hemp flower 106. Typically, the milled size of flower 106 is selected to be suited for an expected application in a product, such as in tea, capsules, food, or powders, or as other ingredients or seasoning for other products.

System 100 may also include a pan 108 for receiving the milled hemp flower. System 100 may include an oven 110 for receiving pan 108 with the milled hemp flower and baking the milled hemp flower to produce a milled, heated hemp flower 124. System 100 may also include a supply of a powder substance 112 that includes one or more of coconut powder 114, a yuca root product 116, such as tapioca maltodextrin derived from yuca root, and acacia fiber 118. System 100 may also include a container 120, which may be sealable, configured to receive a combination 122 of the milled, baked hemp flower and the powder substance. Combination 122 may have a ratio by weight of the hemp flower to the powder substance of about 1:1.5.

As shown in FIG. 2, a method 200 for processing a quantity of hemp flower 102 may include a step of milling 202 the hemp flower to produce milled hemp flower 106. Method 200 may further include a step of heating 204 the milled hemp flower in oven 110. Method 200 may also include a step of combining 206 in container 120 the milled, heated hemp flower 124 with a powder substance 112 that may include one or more of coconut powder 114, yuca root product 116, and/or acacia fiber 118 to produce combination 122. Method 200 may further include a step of stirring 208 together the milled, heated hemp flower and the powder substance. The powder substance used in the combining step of the method may include coconut powder 114, yuca root product 116, such as tapioca maltodextrin, and/or acacia fiber 118, in portions as best suited to the particular application of combination 122.

As also shown in FIG. 2, where powder substance 112 includes coconut powder 114, powder substance 112 may be produced in a second milling step 210 of breaking down a commercially available coconut material, which typically includes the presence of clumps or solid chunks. Preferably this milling step produces a very fine grade coconut powder. Typically, commercially available coconut powder has a consistency of solid chunks and a sifting process may reduce the chunks to a very fine grade powder. For example, the coconut material may be passed through a series of culinary sifters that distribute the coconut material into a coconut powder with particle sizes of about 0.5 mm to about 1 mm. This powder may have an appearance and a feel that is sand-like and very fine.

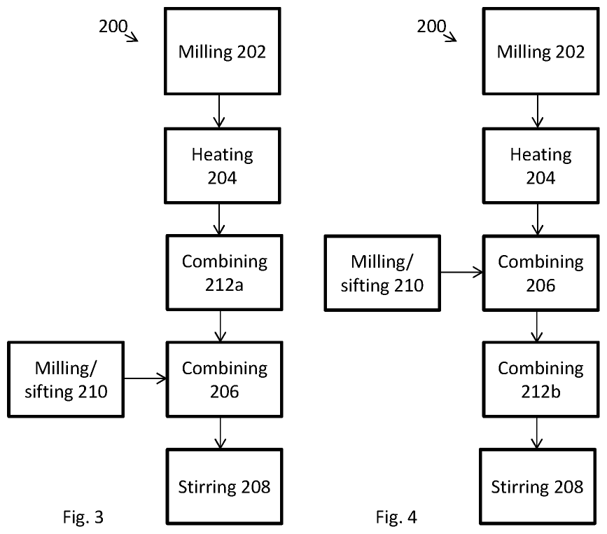

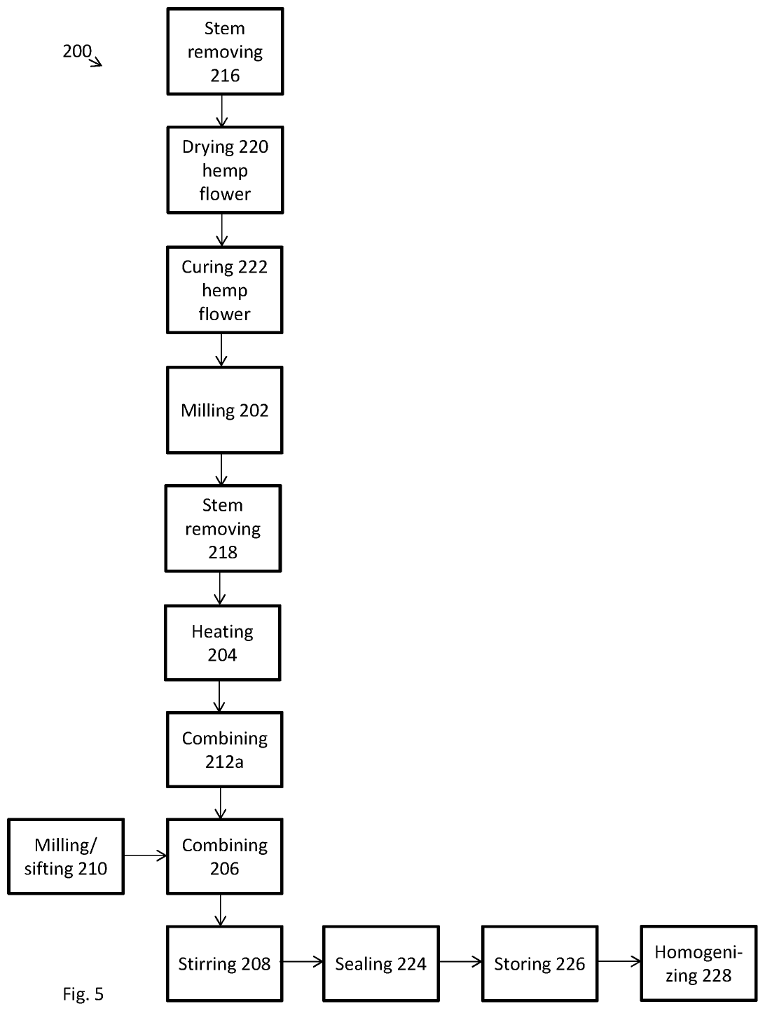

Additionally, and as shown in FIGS. 3 and 4, another combining step 212a, 212b may provide for addition of a quantity of hemp kief 126, which may be added to the flower before or after the combination with the powder substance. Kief is a fine grade, cannabinoid rich byproduct of hemp processing. For example, kief may be in the form of a silty powder that is a mix of small pieces of the flower material, trichomes, and other plant parts. Generally the potency is about twice that of trimmed flower so adding a variable amount of kief to the milled hemp flower and coconut mix may be used to influence the potency of the final product to a higher or a lower state. A typical hemp/kief mix may be a 70/30 respectively, being primarily hemp flower material. As another example, a typical mix for use in capsule products, which are smaller serving sizes, may use a higher portion of kief, for example, an approximately 50/50 mix.

As further examples, for products intended to be dissolved in another medium, the hemp/kief mix may be 0/100, i.e., no hemp, and all kief. Typically this is mixed with the powder substance, for example at 90/10 coconut-mix powder to kief. The resulting product has been found to be highly dissolvable, particularly as compared to hemp mix that may contain large plant parts that do not dissolve well.

Generally, the kief may be processed in the same manner as described above for the hemp flower: sifted or otherwise milled or processed to reduce large parts to smaller. Similarly the kief is typically decarboxylated and may be mixed and then cured with the coconut-mix powder.

Heating step 204 of method 200 may include placing milled hemp flower 106 on pan 108 to a depth of not more than about 1.5-inches and then placing pan 108 with milled hemp flower 106 in oven 110. Heating step 204 may include baking the milled hemp flower in the oven at a temperature between about 230° F. and about 240° F. Heating step 204 may also include baking the milled hemp flower in the oven for about 30 minutes, then a step 214 of removing and stirring the milled hemp flower and returning pan 108 and milled hemp flower 106 to oven 110 for additional baking for about 20 minutes, or between about 15 and about 30 minutes and/or until golden brown.

As shown in FIG. 5, method 200 may also include, before milling step 202, a first step 216 of removing stems from the hemp flower and may further include, after the milling step, a second step 218 of removing stems from the hemp flower. The method may include a step 220, before the milling step, of drying the hemp flower. The method may including a step 222, before the milling step, of curing hemp flower 102.

Milling step 202 of method 200 may include processing the hemp flower to a particle size of not greater than about 2-mm. Milling step 202 of method 200 may include processing the hemp flower to a particle size of between about 1-mm and about 2-mm.

Method 200 may include that milled, heated hemp flower 124 and powder substance 112 define a ratio by weight of the hemp flower to the powder substance of about 1:1.5.

Stirring step 208 of method 200 may include stirring until milled, heated hemp flower 124 and powder substance 112 are evenly distributed and clump-free. Stirring step 208 may also include combining together the milled, heated hemp flower and the powder substance in a sealable container 120. Method 200 may include, after stirring step 208, a step 224 of sealing container 120 and a step 226 of storing container 120 in a cool location for a period of between about 24 and about 72 hours. The method may include, after the storing step, a step 228 of homogenizing the milled hemp flower and powder substance.

Other powder substances may be used alternatively or in addition to coconut powder, such as rice milk powder, almond milk powder, or other nut milk powder, or alternative milk powder.

Specific details are given in the above description to provide a thorough understanding of the embodiments. However, it is understood that the embodiments may be practiced without these specific details. For example, structures be shown in simplified diagrams in order not to obscure the embodiments in any detail. In other instances, well-known processes, structures, and techniques may be shown without unnecessary detail in order to avoid obscuring the embodiments.

While the principles of the disclosure have been described above in connection with specific apparatuses and methods, it is to be clearly understood that this description is made only by way of example and not as limitation on the scope of the disclosure.

What is claimed is:

1. A method for processing a quantity of hemp flower, the method comprising the steps of:
a. milling the hemp flower to produce a milled hemp flower;
b. heating the milled hemp flower in an oven;
c. combining the milled, heated hemp flower with a powder substance that includes a coconut powder;
d. stirring together the milled, heated hemp flower and the powder substance.

2. The method of claim 1 further wherein the combining step uses the powder substance wherein the powder substance includes yuca root.

3. The method of claim 1 further wherein the combining step uses the powder substance wherein the powder substance includes acacia fiber.

4. The method of claim 1 further wherein the heating step includes placing the milled hemp flower on a pan to a depth of not more than about 1.5-inches and then placing the pan with the milled hemp flower in an oven.

5. The method of claim 1 further wherein the heating step includes baking the milled hemp flower in an oven at a temperature between about 230° F. and about 240° F.

6. The method of claim 4 further wherein the heating step includes placing the milled hemp flower on a pan to a depth of not more than about 1.5-inches and then baking the milled hemp flower in the oven for about 30 minutes, then removing from the oven and stirring the milled hemp flower and returning the pan and the milled hemp flower to the oven for additional baking for about 20 minutes.

7. The method of claim 1 further including, before the milling step, a first step of removing stems from the hemp flower.

8. The method of claim 7 further including, after the milling step, a second step of removing stems from the hemp flower.

9. The method of claim 1 further including a step, before the milling step, of drying the hemp flower.

10. The method of claim 1 further including a step, before the milling step, of curing the hemp flower.

11. The method of claim 1 wherein the step of milling the hemp flower includes processing the hemp flower to a particle size of not greater than about 2-mm.

12. The method of claim 1 wherein the step of milling the hemp flower includes processing the hemp flower to a particle size of between about 1-mm and about 2-mm.

13. The method of claim 1 wherein the powder substance additionally comprises yuca root and acacia fiber.

14. The method of claim 1 wherein the milled, heated hemp flower and the powder substance define a ratio by weight of the hemp flower to the powder substance of about 1:1.5.

15. The method of claim 1 wherein the stirring step includes stirring until the milled, heated hemp flower and the powder substance are evenly distributed and clump-free.

16. The method of claim 1 wherein the stirring step includes combining together the milled, heated hemp flower and the powder substance in a sealable container.

17. The method of claim 16 further including, after the stirring step, a step of sealing the container and a step of storing the container in a cool location for a period of between about 24 and about 72 hours.

18. The method of claim 17 further including, after the storing step, a step of homogenizing the milled hemp flower and powder substance.

19. A system for processing hemp, the system configured for processing a supply of hemp flower, the system comprising:
a. a processor configured for milling the supply of hemp flower to produce a milled hemp flower;
b. a pan for receiving the milled hemp flower;
c. an oven for receiving the pan containing the milled hemp flower and baking the milled hemp flower;
d. a supply of a powder substance that includes coconut powder, yuca root, and acacia fiber;
e. a sealable container configured to receive a combination of the milled, baked hemp flower and the powder substance in a ratio by weight of the hemp flower to the powder substance of about 1:1.5.

20. A processed hemp product comprising:
a. hemp flower;
b. a combination of
i. powdered coconut milk;
ii. tapioca maltodextrin; and
iii. acacia fiber
wherein the hemp flower and the combination define a ratio by weight of the hemp flower to the combination of about 1:1.5.
